(19) United States
(12) Patent Application Publication
(10) Pub. No.: US 2026/0160214 A1
(43) Pub. Date: Jun. 11, 2026

(54) FAST AWAKENING OXYGEN SENSOR

(71) Applicant: GM Global Technology Operations LLC, Detroit, MI (US)

(72) Inventors: Michael Zumbaugh, Dexter, MI (US); Rafat F. Hattar, Royal Oak, MI (US); Vijay A. Ramappan, Novi, MI (US)

(21) Appl. No.: 18/976,569

(22) Filed: Dec. 11, 2024

(51) Int. Cl. F02D 41/14; B60W 20/13; F02D 41/38; G01M 15/10

(52) U.S. Cl. CPC F02D 41/1494; B60W 20/13; F02D 41/1454; F02D 41/38; G01M 15/104; B60W 2510/244; F02D 2200/50

(57) ABSTRACT

A vehicle includes at least a first oxygen sensor having a sensing element and a heater. The vehicle also includes an electric energy storage system, an internal combustion engine, and a controller controllably coupled to the electric energy storage system, the internal combustion engine and in communication with the at least a first oxygen sensor. The controller includes an oxygen sensor awakening module configured to respond to the controller receiving a prestart notification indicative of an imminent internal combustion engine start by comparing a temperature of the sensing element of the first oxygen sensor to a target temperature and heating the sensing element until the sensing element is at least the target temperature when the heating element is below the target temperature, and starting the internal combustion engine subsequent to heating the sensing element.

The subject disclosure relates to vehicles, and in particular to a system for awakening an oxygen sensor.

Vehicles including internal combustion engines (ICEs) utilize oxygen (O2) sensors to allow for a closed-loop fuel control based on the O2 sensor. The closed-loop fuel control allows for ideal tradeoffs between individual emission criteria, while reducing variation from tolerance stack up, vehicle aging, test parameters and the like, thereby minimizing emissions from the ICE.

However, when O2 sensors are engaged while the temperature of the sensing element is too low condensation can occur resulting in water droplets being deposited on a sensing element. When the sensing element is operated while water droplets are present on the sensing element, a cracking issue can occur damaging the O2 sensor and potentially requiring the O2 sensor to be replaced. Preconditioning the O2 sensor by adjusting the temperature of the sensing element using a heater allows the O2 sensor to be operated without concern for condensation.

In existing systems, the preconditioning results in a delay of several seconds after the ICE is started and before the O2 sensor can be operated. During this period, the fuel control is operated in an open-loop manner, and tailpipe emissions are less able to be controlled.

It is desirable to minimize or eliminate open loop fuel control operations, thereby improving control of tailpipe emissions.

### SUMMARY

In one exemplary embodiment a vehicle includes at least a first oxygen sensor having a sensing element and a heating element. The vehicle also includes an electric energy storage system, an internal combustion engine, and a controller controllably coupled to the electric energy storage system, the internal combustion engine and in communication with the at least a first oxygen sensor. The controller includes an oxygen sensor awakening module configured to respond to the controller receiving a prestart notification indicative of an imminent internal combustion engine start by comparing a temperature of the sensing element of the first oxygen sensor to a target temperature and heating the sensing element until the sensing element is at least the target temperature when the heating element is below the target temperature, and starting the internal combustion engine subsequent to heating the sensing element.

In addition to one or more of the features described herein the at least a first oxygen sensor includes a second oxygen sensor, and wherein the oxygen sensor awakening module controls the first oxygen sensor and the second oxygen sensor.

In addition to one or more of the features described herein the vehicle is a hybrid electric vehicle, and wherein the prestart notification is a state of charge of the electric energy storage system falling below a charge sustaining limit of the electric energy storage system.

In addition to one or more of the features described herein the prestart notification is a token object entering a predefined proximity of the vehicle.

In addition to one or more of the features described herein the prestart notification is engagement of at least one vehicle system by an operator.

In addition to one or more of the features described herein starting the internal combustion engine subsequent to heating the sensing element to the threshold temperature comprises starting the internal combustion engine in a closed-loop fuel control.

In addition to one or more of the features described herein heating the sensing element until the sensing element is at least the target temperature when the heating element is below the target temperature comprises providing power to the heater according to a duty cycle, and wherein the duty cycle is dependent on a difference between the temperature of the sensing element and the target temperature.

In addition to one or more of the features described herein the target temperature is a dew point of the sensing element.

In addition to one or more of the features described herein comparing the temperature of the sensing element of the first oxygen sensor to the target temperature is continuously performed until the internal combustion engine is started and wherein the duty cycle is adjusted based on a current difference between the temperature of the sensing element and the target temperature.

In another exemplary embodiment a vehicle controller includes a processor and a non-transitory memory. The non-transitory memory stores an oxygen sensor awakening module. The oxygen sensor awakening module is configured to respond to receiving a prestart notification indicative of an imminent start of an internal combustion engine by comparing a temperature of a sensing element of a first oxygen sensor to a target temperature, causing the sensing element to be heated until the sensing element is at least the target temperature when the sensing element is below the target temperature, and causing the internal combustion engine to be started subsequent to heating the sensing element.

In addition to one or more of the features described herein causing the internal combustion engine to be started subsequent to heating the sensing element comprises starting the internal combustion engine in a closed-loop fuel control mode.

In yet another exemplary embodiment method for awakening an oxygen sensor in a vehicle includes receiving a prestart notification indicative of an imminent start of an internal combustion engine, comparing a temperature of a sensing element of a first oxygen sensor to a target temperature and heating the sensing element until the sensing element is at least the target temperature when the heating element is below the target temperature in response to the prestart notification, and starting the internal combustion engine subsequent to heating the sensing element.

In addition to one or more of the features described herein, the method further includes comparing a temperature of a sensing element of a second oxygen sensor to a target temperature and heating the sensing element of the second oxygen sensor until the sensing element of the second oxygen sensor is at least the target temperature when the sensing element of the second oxygen sensor is below the target temperature in response to the prestart notification.

In addition to one or more of the features described herein the prestart notification is a state of charge of an electric energy storage unit falling below a charge sustaining limit of the electric energy storage unit, and wherein the first oxygen sensor is an oxygen sensor of a hybrid electric vehicle.

In addition to one or more of the features described herein the prestart notification is a token object entering a predefined proximity of a vehicle.

In addition to one or more of the features described herein the prestart notification is engagement of at least one vehicle system by an operator.

In addition to one or more of the features described herein starting the internal combustion engine subsequent to heating the sensing element comprises starting the internal combustion engine in a closed-loop fuel control.

In addition to one or more of the features described herein heating the sensing element until the heating element is at least the target temperature when the heating element is below the target temperature comprises providing power to a heating element according to a duty cycle, and wherein the duty cycle is dependent on a difference between the temperature of the sensing element and the target temperature.

In addition to one or more of the features described herein the target temperature is a dew point of the sensing element.

In addition to one or more of the features described herein comparing the temperature of the sensing element of the first oxygen sensor to the target temperature is continuously performed until the internal combustion engine is started and wherein the duty cycle is adjusted based on a current difference between the temperature of the sensing element and the target temperature.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic view of a hybrid electric vehicle;

FIG. 2 is a process for preconditioning an oxygen (O2) sensor for the vehicle of FIG. 1; and

FIG. 3 is a graph illustrating a relationship between O2 sensor temperature and a heater duty cycle.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term controller refers to a system including at least one processor and a memory, where the system is arranged to control operation of a function. The system may be a dedicated controller including a single processor and a corresponding memory, a general controller including processors and memories storing modules for causing one or more of the processors to operate the function, a distributed system including multiple distribute processors and memories in communication with each other and configured to operate the function in conjunction with each other, or any similar system able to control the function.

In a general embodiment of the system disclosed herein, a vehicle controller receives a pre-warning that a vehicle internal combustion engine (ICE) is about to be engaged. In response to the pre-warning, a vehicle controller identifies a target temperature for a sensing element of one or more oxygen (O2) sensors and engages a sensor heater to raise the sensing element to the target temperature prior to starting the ICE. The ICE is operated with a closed-loop fuel control using the O2 sensor(s) for a full duration of the ICE operations, thereby eliminating an initial warm up period of open-loop fuel control.

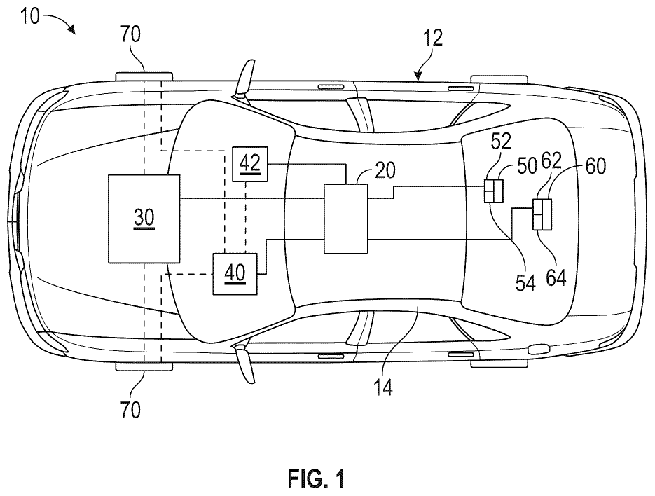

In accordance with an exemplary embodiment, FIG. 1 illustrates a top down view of a hybrid electric vehicle 10 (vehicle 10). The relative locations of components and structures within the vehicle 10 are provided for ease of illustration and do not denote or imply actual positioning of the components in a practical example. The vehicle 10 includes a body 12 defining a passenger compartment 14. A general vehicle controller (controller 20) provides operational controls for one or more systems within the vehicle 10. In alternate examples, the controller may be replaced with or supplemented using dedicated systems controllers operating in conjunction to provide vehicle 10 controls.

The controller 20 provides control signals to an ICE 30, and an electric drive motor 40. Both the ICE 30 and the electric drive motor 40 are connected to wheels 70 such that rotation is provided from the ICE 30 and/or the electric drive motor 40 to the wheels 70. The electric drive motor 40 is connected to an electrical energy storage system (energy storage system 42), with the energy storage system 42 providing electric power for the electric drive motor 40. The energy storage system 42 is in communication with the controller 20, with the controller 20 monitoring charging and energy storage parameters of the energy storage system 42 according to any conventional monitoring system.

A pair of O2 sensors 50, 60 are connected to the controller 20 and provide sensor outputs indicative of an O2 level within exhaust from the ICE 30 at the location of the O2 sensor 50, 60. In the example of vehicle 10, a first of the O2 sensors 50 is positioned upstream of a catalytic converter within the exhaust system and is referred to as a pre sensor. A second of the O2 sensors is positioned downstream of the catalytic converter and is referred to as a post sensor 60. In alternate examples the processes described herein may be adapted for additional, or alternately positioned, O2 sensors (e.g. an O2 sensor within the catalytic converter.)

Each sensor 50, 60 includes a corresponding sensing element 52, 62 and a corresponding sensor heater 54, 64. During a preconditioning step, the sensor heater(s) 54, 64 is provided electric power according to a duty cycle, with the duty cycle being controlled by the controller 20. The operational control signals defining and controlling the duty cycle and power provision can be provided according to any conventional method. The electric power causes the sensor heater(s) 54, 64 to raise the temperature of the corresponding sensing element 52, 62.

In order to minimize tailpipe emissions from a hybrid electric vehicle, the controller 20 includes a process that monitors for indications that the ICE 30 is about to be started (referred to as prestart notifications), and engages a sensor 50, 60 preheating process in response to the prestart notification. Preheating the sensing element 52, 62 allows the ICE 30 to operate in the closed-loop fuel control mode through the entire ignition cycle without potential condensation damage.

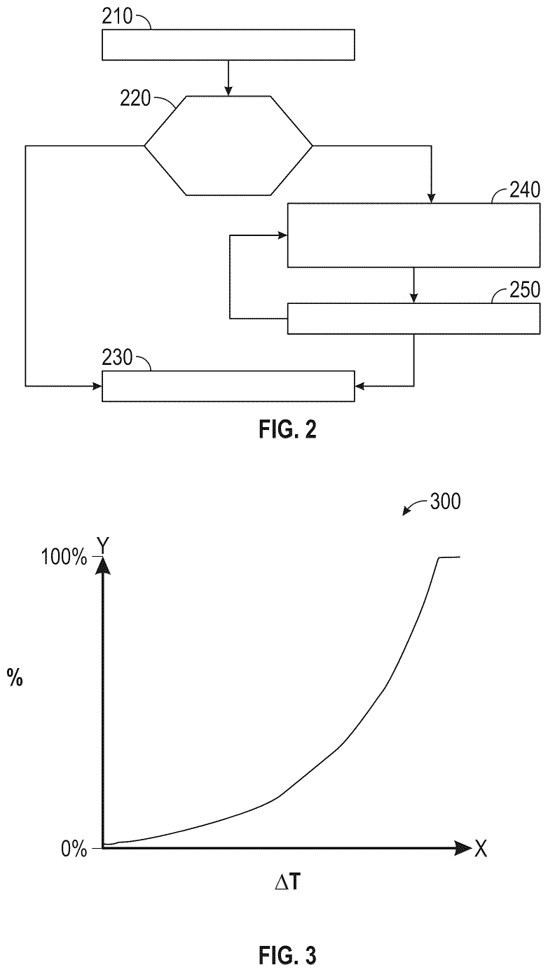

With continued reference to FIG. 1, FIG. 2 illustrates a process 200 for initializing the O2 sensors 50, 60 prior to initiation of the ICE 30, thereby ensuring that the ICE 30 is operated in closed-loop fuel control for an entire ignition cycle.

Initially, the controller 20 receives a prestart notification at a receive prestart notification step 210. The prestart notification is a signal available to the controller 20 that indicates that ignition of the ICE 30 is imminent.

When the vehicle is a hybrid electric vehicle, as in the vehicle 10, of FIG. 1, the prestart notification can be accomplished by monitoring a state of charge and a charge sustaining limit of the energy storage unit 42. When a state of charge of the energy storage unit 42 falls below the charge sustaining limit, this is indicative that the ICE 30 is about to start and step 210 occurs.

In alternate examples, the prestart notification may be accomplished via other indicators that ignition of the ICE 30 is imminent. By way of example, a fob proximity detection may identify that a driver's keyfob (or other token object) is approaching the vehicle 10. Based on this characteristic, the controller identifies that the user is about to start the vehicle 10 and the receive prestart notification step 210 occurs. Similarly, when a user engages one or more vehicle systems (e.g. climate control, window control etc.) indicative that the user is preparing to operate the vehicle 10, the controller 20 may identify that an ICE 30 ignition is imminent and trigger the receive prestart notification step 210.

After a prestart notification is received the controller 20 responds by determining a target temperature of the sensing element(s) 52, 62 of O2 sensor(s) 50, 60 and comparing a current temperature of the O2 sensing element(s) 52, 62 to the target temperature in a comparison check 220.

The target temperature is dependent on a dew point of the O2 sensing element(s) 52, 62 and can be determined according to:

$${T}_{d} = \frac{c \cdot ( \frac{b \cdot T}{c + T} + ln ( RH / 100 ) )}{b - ( \frac{b \cdot T}{c + T} + ln ( RH / 100 ) )}$$

Where (Td) is the dew point temperature in degrees Celsius, (T) is the air temperature in degrees Celsius, (RH) is the relative humidity in percentage, and (b) and (c) are constants. In one example, the constants are b=17.625 and c=243.04 C. The specific temperatures may be determined using available sensors and sensing systems such as mass air flow sensors.

The target temperature (Td) provides a threshold above which no preheating of the sensing element 52, 62 is required (i.e. the sensing element is warm enough that no condensation will form). When the temperature of the sensing element(s) 52, 62 is below the threshold, pre-heating is required in order to ensure that no condensation occurs on the sensing element(s) 52, 62.

When the comparison check 220 determines that the temperature of the sensing element(s) 52, 62 is greater than or equal to the threshold, the process 200 proceeds to start the engine with the engine operating in a closed-loop fuel control in an engine start step 230, after which the engine operations proceed as normal.

When the temperature of the sensing element 52, 62 is less than the threshold, the process 200 proceeds to power on the heater(s) 54, 64 in a power on O2 heater step 240. In order to save power and prevent incidental heating overshoot (heating the sensing element 52, 62 beyond the target temperature) that may place undue stresses on the sensing element(s) 52, 62, the controller 20 adjusts how much power is provided to the heater(s) 54, 64 based on a difference between the temperature of the sensing element(s) 52, 62 and the dew point. In one example, the magnitude of power provided to the heater(s) 54, 64 is adjusted by altering a duty cycle of the heater(s) 54, 64.

With continued reference to FIGS. 1 and 2, FIG. 3 is a graph 300 illustrating a relationship between a heater duty cycle (y-axis) and a difference between the temperature of the sensing element(s) 52, 62 and the dew point temperature (x-axis). As shown in the graph 300, as the difference increases, the duty cycle increase to 100%, and then plateaus at 100%, 100% duty cycle represents the maximum amount of power that can be provided to the heater(s) 54, 64 and the fastest the temperature can be increased. The specific curve of a given implementation depends on the practical components and can be determined by one of skill in the art.

Once the duty cycle has been determined, the process 200 powers the sensor heater(s) 54, 64 and heats the O2 sensor in a heat O2 sensor step 250. In some examples, such as the illustrated example of FIG. 2, the duty cycle determination at step 240 and the heating of the sensing element(s) 52, 62 is looped continuously until the sensing element(s) 52, 62 reach the target temperature, thereby allowing the power provided to be continuously adjusted and minimizing any overshoot.

In alternate examples, the process 200 can calculate the duty cycle a single time, and the sensor heater(s) 54, 64 are heated at that duty cycle until the target temperature is met.

Once the target temperature is reached, the process 200 proceeds to the engine start step 230.

In some examples, the prestart notification may arrive too close to the user initiating an engine cycle for the pre-heating process 200 to raise the sensing element temperatures above the target temperature before ignition. In such examples, the process 200 is still operated. When the user begins the ignition cycle and the heating step 250 is still operating the engine is run in an open-loop fuel control until the process 200 is completed, thereby achieving at least a portion of the benefits of the process 200.

By using the process 200 of FIG. 2, the vehicle 10 can achieve an immediate air/fuel closed-loop control which allows fuel scheduling to follow a target profile as a function of intake valve temperature optimizing emissions performance, lowering engine out and tailpipe emissions and improving converter light off performance. This benefit is achieved without requiring any reliance on market fuel variability, improves combustion stability within the ICE 30, lowers fuel consumption, and improves emissions performance.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
at least a first oxygen sensor, the first oxygen sensor comprising a sensing element and a heating element;
an electric energy storage system;
an internal combustion engine;
a controller controllably coupled to the electric energy storage system, the internal combustion engine and in communication with the at least a first oxygen sensor the controller including an oxygen sensor awakening module configured to respond to the controller receiving a prestart notification indicative of an imminent internal combustion engine start by comparing a temperature of the sensing element of the first oxygen sensor to a target temperature and heating the sensing element until the sensing element is at least the target temperature when the heating element is below the target temperature, and starting the internal combustion engine subsequent to heating the sensing element.

2. The vehicle of claim 1, wherein the at least a first oxygen sensor includes a second oxygen sensor, and wherein the oxygen sensor awakening module controls the first oxygen sensor and the second oxygen sensor.

3. The vehicle of claim 1, wherein the vehicle is a hybrid electric vehicle, and wherein the prestart notification is a state of charge of the electric energy storage system falling below a charge sustaining limit of the electric energy storage system.

4. The vehicle of claim 1, wherein the prestart notification is a token object entering a predefined proximity of the vehicle.

5. The vehicle of claim 1, wherein the prestart notification is engagement of at least one vehicle system by an operator.

6. The vehicle of claim 1, wherein starting the internal combustion engine subsequent to heating the sensing element to the threshold temperature comprises starting the internal combustion engine in a closed-loop fuel control.

7. The vehicle of claim 1, wherein heating the sensing element until the sensing element is at least the target temperature when the heating element is below the target temperature comprises providing power to the heater according to a duty cycle, and wherein the duty cycle is dependent on a difference between the temperature of the sensing element and the target temperature.

8. The vehicle of claim 7, wherein the target temperature is a dew point of the sensing element.

9. The vehicle of claim 7, wherein comparing the temperature of the sensing element of the first oxygen sensor to the target temperature is continuously performed until the internal combustion engine is started and wherein the duty cycle is adjusted based on a current difference between the temperature of the sensing element and the target temperature.

10. A vehicle controller comprising a processor and a non-transitory memory, the non-transitory memory storing an oxygen sensor awakening module, wherein the oxygen sensor awakening module is configured to respond to receiving a prestart notification indicative of an imminent start of an internal combustion engine by comparing a temperature of a sensing element of a first oxygen sensor to a target temperature, and causing the sensing element to be heated until the sensing element is at least the target temperature when the sensing element is below the target temperature, and causing the internal combustion engine to be started subsequent to heating the sensing element.

11. The vehicle controller of claim 10, wherein causing the internal combustion engine to be started subsequent to heating the sensing element comprises starting the internal combustion engine in a closed-loop fuel control mode.

12. A method for awakening an oxygen sensor in a vehicle comprising:
receiving a prestart notification indicative of an imminent start of an internal combustion engine start;
comparing a temperature of a sensing element of a first oxygen sensor to a target temperature and heating the sensing element until the sensing element is at least the target temperature when the sensing element is below the target temperature in response to the prestart notification; and
starting the internal combustion engine subsequent to heating the sensing element.

13. The method of claim 12, further comprising comparing a temperature of a sensing element of a second oxygen sensor to a target temperature and heating the sensing element of the second oxygen sensor until the sensing element of the second oxygen sensor is at least the target temperature when the heating element of the second oxygen sensor is below the target temperature in response to the prestart notification.

14. The method of claim 12, wherein the prestart notification is a state of charge of an electric energy storage unit falling below a charge sustaining limit of the electric energy storage unit, and wherein the first oxygen sensor is an oxygen sensor of a hybrid electric vehicle.

15. The method of claim 12, wherein the prestart notification is a token object entering a predefined proximity of a vehicle.

16. The method of claim 12, wherein the prestart notification is engagement of at least one vehicle system by an operator.

17. The method of claim 12, wherein starting the internal combustion engine subsequent to heating the sensing element comprises starting the internal combustion engine in a closed-loop fuel control.

18. The method of claim 12, wherein heating the sensing element until the sensing element is at least the target temperature when the sensing element is below the target temperature comprises providing power to a heating element according to a duty cycle, and wherein the duty cycle is dependent on a difference between the temperature of the sensing element and the target temperature.

19. The method of claim 18, wherein the target temperature is a dew point of the sensing element.

20. The method of claim 19, wherein comparing the temperature of the sensing element of the first oxygen sensor to the target temperature is continuously performed until the internal combustion engine is started and wherein the duty cycle is adjusted based on a current difference between the temperature of the sensing element and the target temperature.
